(19) United States
(12) Patent Application Publication
(10) Pub. No.: US 2008/0031191 A1
(43) Pub. Date: Feb. 7, 2008

(54) Shared control channel structure for multi-user MIMO resource allocation

(75) Inventors: Tsuyoshi Kashima, Yokohama (JP); Olav E. Tirkkonen, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/888,775

(22) Filed: Aug. 1, 2007

Related U.S. Application Data
(60) Provisional application No. 60/835,002, filed on Aug. 1, 2006.

(51) Int. Cl. H04Q 7/20

(52) U.S. Cl. 370/329; 375/260

(57) ABSTRACT

An allocation of radio resources is signaled with a multi-user multiple-input-multiple-output MU-MIMO field indicating whether MU-MIMO is enabled in the allocation. The structure of the signal allocating the resources changes depending on whether the MU-MIMO field indicates enabled or not. For downlink signaling, an additional length field indicates a length of another component of the allocation apart from that listing user identifiers. A component listing which resource blocks are allocated for MU-MIMO is one embodiment, and it may be split to indicate per-stream. Multiple embodiments are shown with various assumptions as to mapping between components of the resource allocation and tradeoffs of flexibility and signaling overhead, for method, apparatus, program, and chip.

### PRIORITY AND CROSS REFERENCE TO RELATED APPLICATIONS

This application claims priority to provisional U.S. Patent Application Ser. No. 60/835,002, filed on Aug. 1, 2006 and incorporated herein by reference. This application is further related to the U.S. patent application Ser. No. 11/787,172, filed on Apr. 13, 2007 (priority to provisional U.S. Patent Application 60/791,662, filed on Apr. 13, 2006), which is also incorporated herein by reference.

### TECHNICAL FIELD

The exemplary and non-limiting embodiments of this invention relate generally to wireless communications systems, devices, methods and computer program products and, more specifically, relate to resource allocation for a wireless user equipment.

### BACKGROUND

The following abbreviations are defined as follows:
3GPP third generation partnership project
C-RNTI cell radio network temporary identifier
DL downlink (Node B to UE)
FDM frequency division multiplexing
HARQ hybrid auto-repeat request
LTE long term evolution (e.g., 3.9 G)
Node-B base station
OFDM orthogonal frequency division multiplex
PRB physical resource block
RB resource block
RNC radio network control
RNTI radio network temporary identity
TFI transport format indicator
UE user equipment
UL uplink (UE to Node B)
UMTS universal mobile telecommunications system
UTRAN UMTS terrestrial radio access network
E-UTRAN evolved UTRAN
VRB virtual resource block
L-VRB localized VRB
D-VRB distributed VRB

In E-UTRAN a shared channel is used for data transmission. As a result, a flexible resource allocation scheme is required in order to achieve a high performance and high throughput communication system. However, in order to reduce the overhead of control signaling, the structure of the DL control signal for resource allocation should be carefully considered.

The inventors collaborated in such control signaling with reduced overhead in the related US patent application Ser. No. 11/787,172 cross-referenced above. The generalized structure of the downlink control channel in Ser. No. 11/787,172 includes three distinct components of downlink control signaling: at least one allocation entry, allocation type bits, and a UE index sequence. These components are detailed further below, and.may be transmitted jointly or separately. These teachings expand and improve upon the solution described in US patent application Ser. No. 11/787,172, which is incorporated herein by reference in its entirety.

### SUMMARY

In accordance with an exemplary embodiment of the invention, there is provided a method that includes determining a radio resource allocation for a plurality of user equipments, and transmitting over a shared control channel to the plurality of user equipments a control signal comprising the resource allocation and a multi-user multiple-input-multiple-output MU-MIMO field indicating whether MU-MIMO is enabled in the allocation.

In accordance with another exemplary embodiment of the invention is an apparatus that includes a processor and a transceiver. The processor is adapted to determine a radio resource allocation for a plurality of user equipments. The transceiver is adapted to transmit over a shared control channel to the plurality of user equipments a control signal comprising the resource allocation and a multi-user multiple-input-multiple-output MU-MIMO field indicating whether MU-MIMO is enabled in the allocation.

In accordance with yet another exemplary embodiment of the invention is a program of machine-readable instructions, tangibly embodied on a memory and executable by a digital data processor, to perform actions directed toward transmitting a resource allocation to a plurality of users. In this embodiment the actions include determining a radio resource allocation for a plurality of user equipments, and transmitting over a shared control channel to the plurality of user equipments a control signal comprising the resource allocation and a multi-user multiple-input-multiple-output MU-MIMO field indicating whether MU-MIMO is enabled in the allocation.

In accordance with yet another exemplary embodiment is an apparatus that includes processing means such as a digital data processor and transmitting means such as a wireless transceiver. The processing means is for determining a radio resource allocation for a plurality of user equipments, and for selecting a first resource allocation structure for the case where MU-MIMO is enabled in the allocation and for selecting a second resource allocation structure for the case where MU-MIMO is not enabled in the allocation. The transmitting means is for transmitting over a shared control channel to the plurality of user equipments a control signal comprising the resource allocation in the selected structure and a multi-user multiple-input-multiple-output MU-MIMO field indicating whether MU-MIMO is enabled in the allocation.

In accordance with still another exemplary embodiment of the invention is a method that includes receiving over a shared control channel a control signal that includes the resource allocation and a multi-user multiple-input-multiple-output MU-MIMO field that indicates whether MU-MIMO is enabled in the resource allocation. The resource allocation in the control signal includes an allocation entry component that has user identifiers that map to indexes of a user index sequence component that maps to resource blocks. Further in the method, one of the user identifiers is mapped to one of the indexes, an allocated resource block is determined from a position of the mapped index, from the MU-MIMO field it is determined whether or not the allocated resource block is allocated for multi-user multiple-input-multiple-output, and then one of transmitting or receiving, as appropriate to the allocation, on the allocated resource block according to the determined MU-MIMO allocation.

In accordance with another exemplary embodiment of the invention is an apparatus that includes a transceiver and a processor. The transceiver is adapted to receive over a shared control channel a control signal comprising the resource allocation and a multi-user multiple-input-multiple-output MU-MIMO field indicating whether MU-MIMO is enabled in the resource allocation. The resource allocation includes an allocation entry component that has user identifiers that map to indexes of a user index sequence component that maps to resource blocks. The processor is adapted to map one of the user identifiers to one of the indexes, to determine an allocated resource block from a position of the mapped index, and to determine from the MU-MIMO field whether or not the allocated resource block is allocated for multi-user multiple-input-multiple-output. The transceiver is further adapted to transmit or receive on the allocated resource block according to the determined MU-MIMO allocation.

These and other exemplary embodiments are detailed below with particularity.

### BRIEF DESCRIPTION OF THE DRAWINGS:

Exemplary embodiments of the present invention are detailed below with reference to the following drawing figures.

FIG. 1 shows a simplified block diagram of various electronic devices that are suitable for use in practicing the exemplary embodiments of this invention.

FIG. 2 depicts the general structure and format of a DL control signal for DL resource allocation in accordance with an exemplary embodiment of this invention, wherein either SISO or MIMO by a single user is employed.

FIG. 3 depicts the general structure and format of a DL control signal for UL resource allocation in accordance with an exemplary embodiment of this invention, wherein either SISO or MIMO by a single user is employed.

FIG. 4A is similar to FIG. 2 for DL resource allocation, but adapted for the case where MU-MIMO is enabled, for an embodiment with a UE pairing restriction.

FIG. 4B shows the allocation resulting from the signal of FIG. 4A.

FIG. 5A is similar to FIG. 3 for UL resource allocation, but adapted for the case where MU-MIMO is enabled, for an embodiment with a UE pairing restriction.

FIG. 5B shows the allocation resulting from the signal of FIG. 5A.

FIGS. 6A-6B are similar respectively to FIGS. 4A-4B for DL resource allocation, but where MU-MIMO is unrestricted by pairing of UEs.

FIGS. 7A-7B are similar respectively to FIGS. 5A-5B for UL resource allocation, but where MU-MIMO is unrestricted by pairing of UEs.

FIG. 7C shows a DL control signal for allocating UL resources adapted from FIG. 7B, wherein the allocation in the first stream continues to the allocation in the second stream.

FIGS. 8A-8B are similar respectively to FIGS. 6A-6B, but where MU-MIMO is enabled for all UEs but SISO and/or single user MIMO is enabled for some but not all UEs and pairing is not required.

FIG. 8C shows an adaptation of FIG. 8B wherein a dummy UE index is used so as to enable SISO and/or single user MIMO for all UEs.

FIG. 9 is a series of process steps according to an aspect of the invention.

### DETAILED DESCRIPTION

The exemplary embodiments of this invention provide a novel control signal structure for DL resource allocation that is well suited for use in, but is not specifically limited to, the E-UTRAN system. The exemplary embodiments of this invention provide the novel control signal structure that enables the flexible scheduling of both distributed and localized allocations in the same sub-frame.

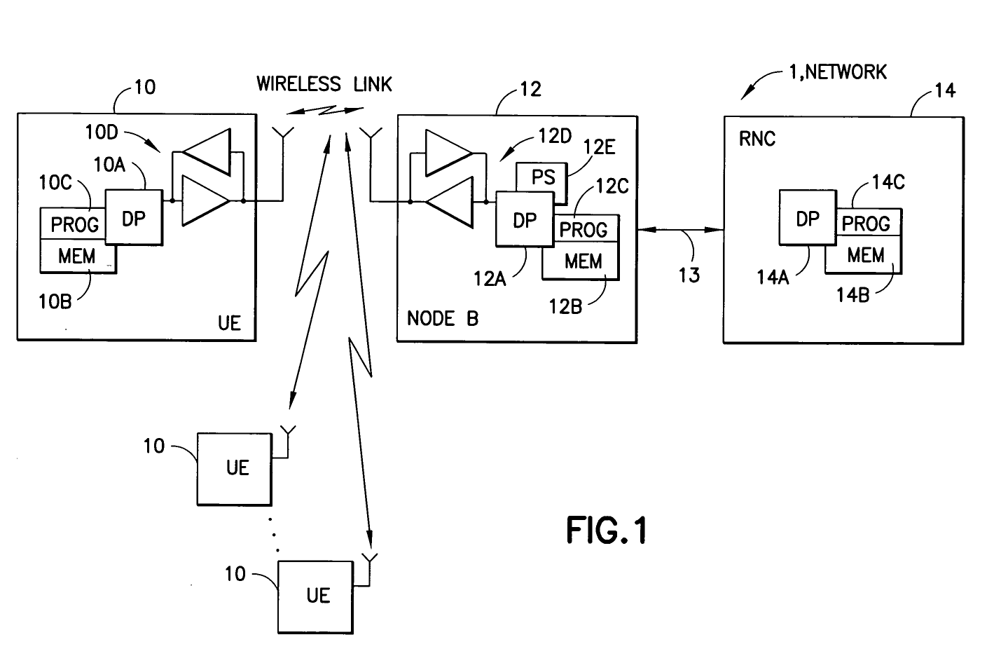

Reference is now made to FIG. 1 for illustrating a simplified block diagram of various electronic devices that are suitable for use in practicing the exemplary embodiments of this invention. In FIG. 1 a wireless network 1 is adapted for communication with a UE 10 via a Node B (base station) 12. There will typically be a plurality of UEs 10. The network 1 may include a control element, such as a RNC 14, which may be referred to as a serving RNC (SRNC). The RNC 14 may be known by different names in various types of networks (e.g., mobility management entity, gateway, etc.), and represents a node higher in the network than the Node B 12. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B 12 is coupled via a data path 13 to the RNC 14 that also includes a DP 14A and a MEM 14B storing an associated PROG 14C. At least one of the PROGs 10C, 12C and 14C is assumed to include program instructions that, when executed by the associated DP, enable the electronic device to operate in accordance with the exemplary embodiments of this invention, as will be discussed below in greater detail. For example, the Node B may include a Packet Scheduler (PS) function 12E that operates in accordance with the exemplary embodiments of this invention to make localized and distributed allocations, as discussed in detail below. In addition, it is assumed that the UEs 10 are constructed and programmed to respond to the localized and distributed allocations that are received on the DL from the Node B.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by the DP 10A of the UE 10 and the other DPs, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

The concept of the PRB and VRB are defined in 3GPP TR 25.814, V1.2.2 (2006-3), entitled “Physical Layer Aspects for Evolved UTRA” (incorporated by reference herein as needed), for example in Section 7.1.1.2.1 “Downlink data multiplexing” (attached as Exhibit C to the above-referenced Ser. No. 60/791,662, priority to US patent application Ser. No. 11/787,172 and incorporated by reference). As is stated, the channel-coded, interleaved, and data-modulated information [Layer 3 information] is mapped onto OFDM time/frequency symbols. The OFDM symbols can be organized into a number of physical resource blocks (PRB) consisting of a number (M) of consecutive sub-carriers for a number (N) of consecutive OFDM symbols. The granularity of the resource allocation should be able to be matched to the expected minimum payload. It also needs to take channel adaptation in the frequency domain into account. The size of the baseline physical resource block, S_{PRB}, is equal to M×N, where M=25 and N is equal to the number of OFDM symbols in a subframe (the presence of reference symbols or control information is ignored here to simplify the description). This results in the segmentation of the transmit bandwidth shown in Table 7.1.1.2.1-1 of 3GPP TR 25.814, reproduced below.

Physical resource block bandwidth and number of physical
resource blocks dependent on bandwidth.

| | Bandwidth (MHz) | | | | | |
|---|---|---|---|---|---|---|
| | 1.25 | 2.5 | 5.0 | 10.0 | 15.0 | 20.0 |
| Physical resource block | 375 | 375 | 375 | 375 | 375 | 375 |
| bandwidth (kHz) | | | | | | |
| Number of available | 3 | 6 | 12 | 24 | 36 | 48 |
| physical resource blocks | | | | | | |

The frequency and time allocations to map information for a certain UE to resource blocks is determined by the Node B scheduler and may, for example, depend on the frequency-selective CQI (channel-quality indication) reported by the UE to the Node B, see Section 7.1.2.1 (time/frequency-domain channel-dependent scheduling). The channel-coding rate and the modulation scheme (possibly different for different resource blocks) are also determined by the Node B scheduler and may also depend on the reported CQI (time/frequency-domain link adaptation).

Both block-wise transmission (localized) and transmission on non-consecutive (scattered, distributed) sub-carriers are also to be supported as a means to maximize frequency diversity. To describe this, the notion of a virtual resource block (VRB) is introduced. A virtual resource block has the following attributes:
Size, measured in terms of time-frequency resource.
Type, which can be either ‘localized’ or ‘distributed’.

All localized VRBs are of the same size, which is denoted as S_{VL}. The size S_{VD} of a distributed VRB may be different from S_{VL}. The relationship between S_{PRB}, S_{VL} and S_{VD} is reserved for future study. Distributed VRBs are mapped onto the PRBs in a distributed manner. Localized VRBs are mapped onto the PRBs in a localized manner. The exact rules for mapping VRBs to PRBs are currently reserved for future study. The multiplexing of localized and distributed transmissions within one subframe is accomplished by FDM.

As a result of mapping VRBs to PRBs, the transmit bandwidth is structured into a combination of localized and distributed transmissions. Whether this structuring is allowed to vary in a semi-static or dynamic (i.e., per sub-frame) way is said to be reserved for future study. The UE can be assigned multiple VRBs by the scheduler. The information required by the UE to correctly identify its resource allocation must be made available to the UE by the scheduler. The number of signaling bits required to support the multiplexing of localized and distributed transmissions should be optimized. The details of the multiplexing of lower-layer control signaling is said currently to be determined in the future, but may be based on time, frequency, and/or code multiplexing.

Embodiments of the present invention enable greater flexibility in resource allocation with minimal additional signaling overhead, as compared to US patent application Ser. No. 11/787,172, by signaling on the DL control signal whether or not multi-user MIMO is being used in the current resource allocation. This may be done by a single bit (e.g., bit “1” or bit “0” to indicate multi-user MIMO or not). Where multi-user MIMO is used and indicated, the structure of the DL control signal may change as compared to the structure used for SISO or single-user MIMO in order to accommodate the multi-user MIMO users. In an embodiment described herein, the DL control signal for multi-user MIMO adds an additional bit sequence over and above those sequences used for SISO or single-user MIMO. Whereas the below description details the DL control signal as within a single sub-frame, the various components of the described sub-frame may be transmitted separately without departing from these teachings. Following are descriptions of downlink control signals for both downlink and uplink resource allocations for various embodiments, proceeding from the simplest to the more complex.

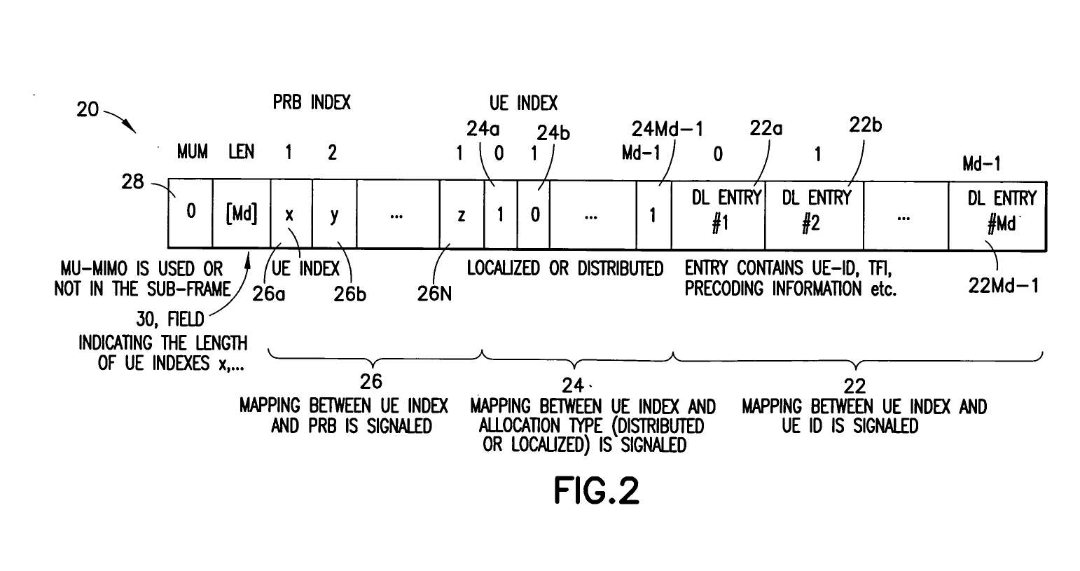

FIG. 2 illustrates an exemplary embodiment of a DL control signal 20 for DL resource allocation in the simple environment wherein the allocated DL resources are for users each employing either a single-user MIMO or SISO (those environments excluding multi-user MIMO). Other exemplary embodiments add to this control signal structure.

As described in the related and above-referenced US Patent application Ser. No. 11/787,172, the DL control signal 20 is characterized by three distinct components: an allocation entry component 22, an allocation type component 24, and a first UE index sequence component 26. The illustrated order of the components is exemplary and not limiting. On the downlink, signals directed to different UEs 10 are multiplexed and sent over the shared downlink control channel.

The allocation entry component 22 carries in each successive entry 22a, 22b, . . . 22Md an identifier (UE-ID) for a particular UE 10, such as, but not limited to, C-RNTI, and possibly TFI, and HARQ control signals, and other information pertinent for the UE 10 such as power control information, information describing the length of the allocation, and so on. The position of each entry of the allocation component 22 is indicated in FIG. 2 by a UE index 0, 1, . . . Md−1, where there are a maximum number of Md UEs present on the control channel over which the control signal 20 is sent. At least one allocation entry is in the allocation component 22, such as for a single UE 10 employing MIMO transmissions. Whether by the position of the entry in which a particular UE-ID is present or more explicit means, each UE-ID is mapped by the allocation component 22 to a UE index (0, 1, . . . Md−1 as illustrated). The UE-ID indicates to which UE 10 the corresponding resource is allocated, TFI indicates what transport format is used in the allocated resource, and the HARQ control signal delivers the necessary HARQ information for the transmission in the allocated resource. The set of allocation entries imply a matching between UE indexes and the UE (UE-ID). For example, the order of the allocation entries may directly indicate the matching. Namely, the “UE index=0” is associated with the UE 10 in the first allocation entry 22a, the “UE index=1” is associated with the UE 10 in the second allocation entry 22b, and so forth.

Each bit (24a, 24b, . . . 24Md−1) of the above-mentioned allocation type component 24 corresponds to each UE index. The allocation type bits indicate whether the UE 10 uses localized allocation or distributed allocation. For example, the UE-ID in the first entry 22a of the allocation entry component 22 corresponds to the first bit 24a of the allocation type component 24 which informs whether its allocation is localized or distributed.

The UE 10 indices illustrated above the entries that are within the allocation type component 24 and the allocation entry component 22 are for explanation and not in those portions of the DL control signal 20. Those UE 10 indices are used in the first UE index component 26, illustrated as x, y . . . z in positions 26a, 26b, . . . 26N of FIG. 2. The UE indices x, y, . . . z correspond to the index mapped to the UE-IDs in the allocation entry component 22. The order of the positions 26a, 26b, . . . 26N within the first UE index component 26 reflects a pre-determined order of PRBs, indicated above the signal 20 as distinct PRB indices 1, 2, . . . N. Thus the first UE index sequence component maps a PRB (by its index 1, 2, . . . N) to a particular UE 10 by the index uniquely mapped to a UE-ID in the allocation entry component 22. The UE index x, y, . . . z, in a particular position 26a, 26b, . . . 26N indicates which UE or which UEs use which PRB.

To the above three components 22, 24, 26, of the DL control signal 20, FIG. 2 adds a multi-user MIMO (MUMIMO) field 28 and a length (LEN) field 30. The MUMIMO field 28 may be a single bit to indicate whether or not multi-user MIMO allocation is being implemented in this DL control signal 20 for the DL resources it allocates. The signal of FIG. 2 indicates by the bit “0” in the MUMIMO field 28 that the DL allocated resources do not employ MU-MIMO.

The length field 30 indicates a length of a UE index (x, y, . . . z). The length field 30 may indicate that length directly (e.g., as a ceiling operation such as ceil log_{—}2 Md), or indirectly as Md from which the length may be calculated. If Md is not explicitly signaled in the length field 30, the value of Md may be obtained implicitly by counting the number of different UE indices in the UE index component 26. A direct indication of length (e.g., ceil log_{—}2 Md) would require a shorter bit field (e.g., 2-3 bits) than an indirect indication (e.g., Md which would require 3-5 bits), but cannot be used with certain optimizations such as non-binary indices, and further requires calculation of the implicitly indicated Md. Varying the bits/values in these fields 28, 30 will be shown in embodiments below.

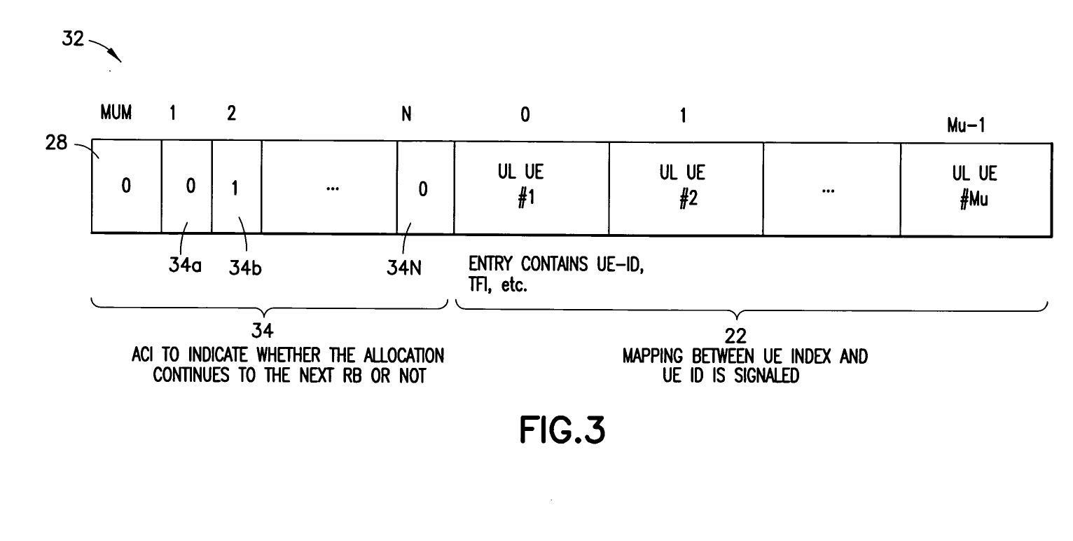

A DL control signal for UL resource allocation is shown in FIG. 3. To enhance flexibility, the number of UEs in the uplink resource allocation need not mirror the number of UEs in the downlink resource allocation, so the uplink embodiments use the value Mu for the number of UEs identified and mapped in the allocation entry component 22 of the uplink allocation control signal 32. An allocation continuation segment 34 includes a bit in each position 34a, 34b, . . . 34N indicating whether or not the allocation of the corresponding PRB (1, 2, . . . N) is continued in the next resource block RB. As illustrated, bit “1” at the position 34b indicates no continuation of the corresponding PRB into the next PRB as one allocation. Bit “0” at the position 34a and 34N indicates the continuation of their corresponding PRBs into the next block as one allocation. Thus, PRBs corresponding to positions 34a and 34b are allocated to one UE.

It is notable that the value Mu, the number of UEs multiplexed on this UL control signal 32 shown in FIG. 3, equals the number of bit “1” of the allocation continuation indicators in the allocation continuation ACI segment 34. This is because the bit “1” indicates the end of the allocation continuation into the next PRB, and its number is the same as the number of allocations. For that reason, the illustrated embodiments do not include an additional field by which the UEs 10 may determine Mu; it is known from the total of the bit “1” in the allocation continuation component 34.

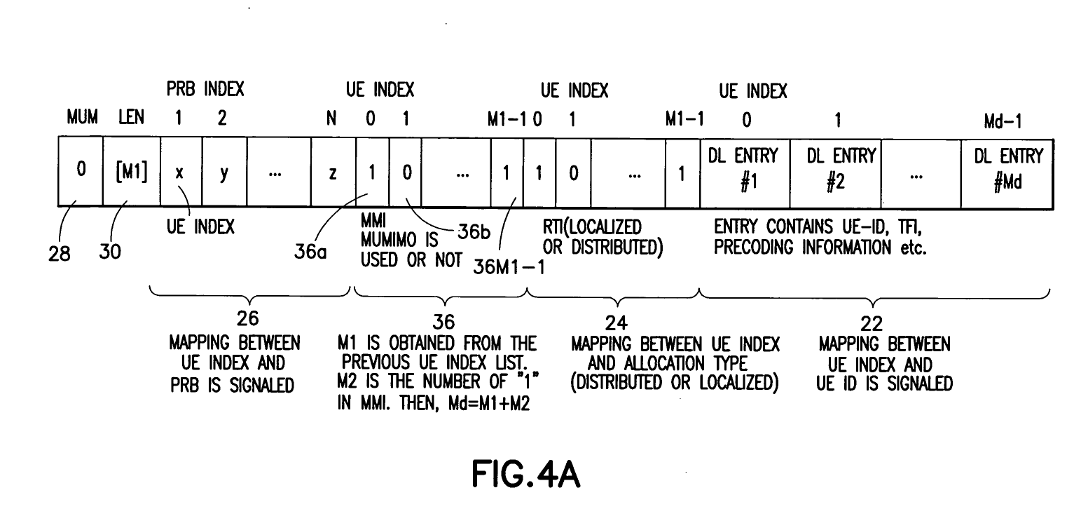

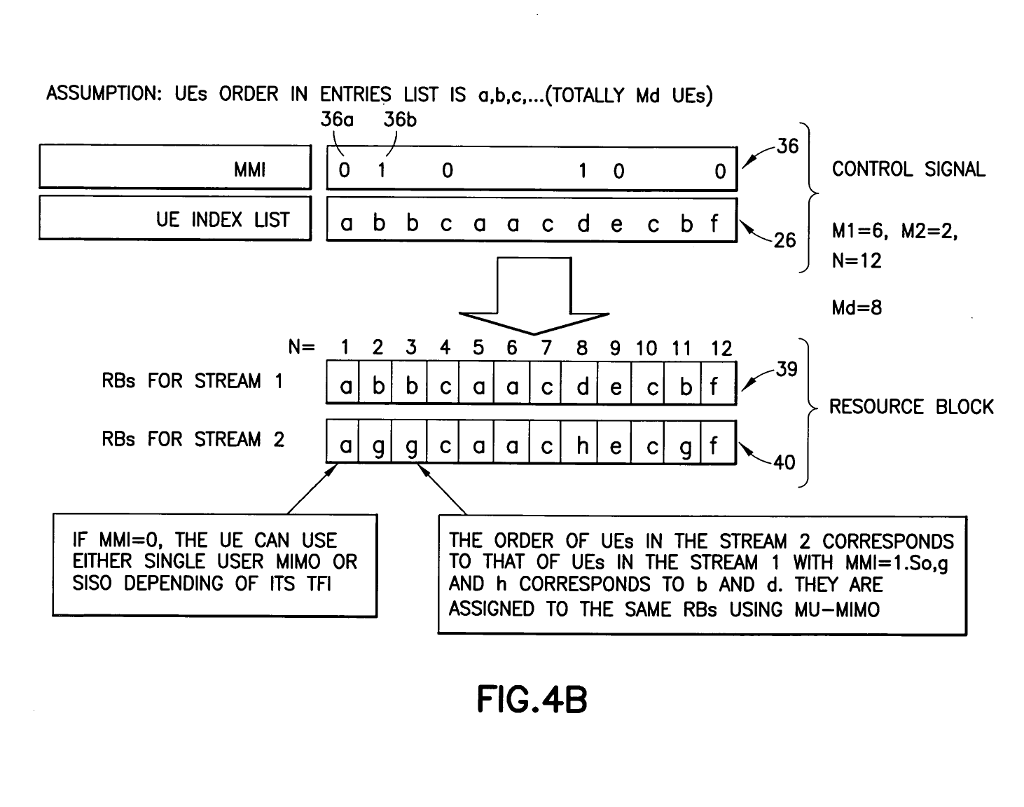

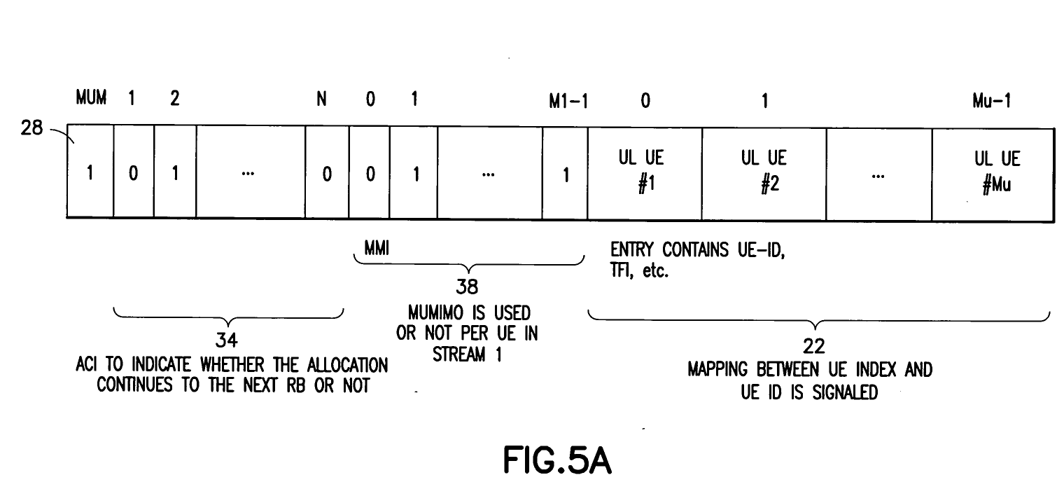

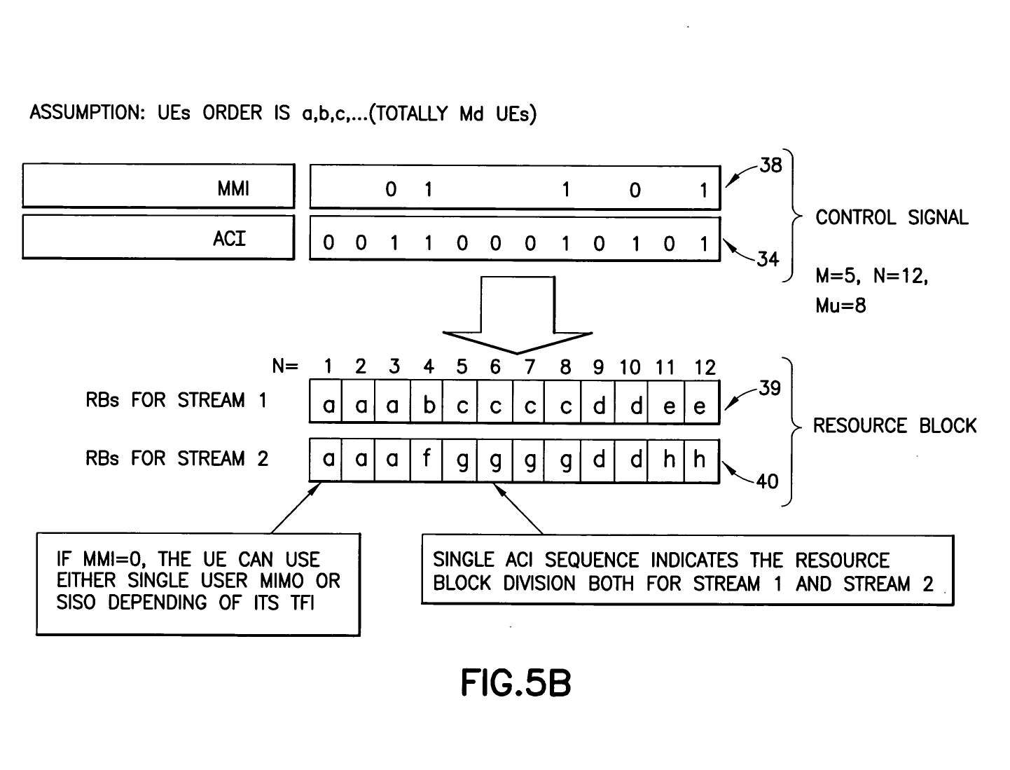

Now is described an embodiment for multi-user MIMO wherein a restriction is imposed that the UEs 10 that apply MU-MIMO are paired. Embodiments for the downlink control signals for DL resource allocation supporting this restricted MU-MIMO are shown at FIGS. 4A-4B. Embodiments for the downlink control signals for UL resource allocation supporting this restricted MU-MIMO are shown for the uplink at FIGS. 5A-5B. Preferably, the network pairs UEs 10 so as to match orthogonal spreading codes among the UE pairs to which resources are allocated. Pairing means that if a UE is paired in one RB with a particular other UE, then in a follow on RB those same two UEs are also paired.

Beginning at FIG. 4A, the segments 22, 24 and 26 are as previously described, but since MU-MIMO is enabled in this embodiment, the bit in the MUMIMO field 28 is set to “1”. The length field 30 is still present, to indicate the length of one UE index directly, or to indicate the number of different UE indices in the UE index sequence component 26, which is for the first stream. An MMI component 36 includes positions 36a, 36b, . . . 36M1−1 that each carry a bit indicative of whether the UE in the UE index list is using MU-MIMO in the allocated RB or not. The allocation type component 24 is also of length M1. Since there can be no more MU-MIMO enabled UEs 10 in the resources allocated by the control signal of FIG. 4A than the total number of UEs 10 to which resources are allocated, then it follows that M1 is always less than or equal to Md.

The restriction noted above arises because in this embodiment the MMI component 36 inherently corresponds to UEs that are in the first stream, and UEs in the second stream are implicitly paired with UEs with MMI=“1” in the first stream. There are M1 UEs allocated on the first stream and M2 UEs allocated on the second stream, so in total there are Md=M1+M2 UEs. Thus, M2 UEs on the second stream and the corresponding M2 UEs on the first stream are using MUMIMO; the remainder M1−M2 UEs are only on the first stream and therefore not using MU-MIMO (only SISO or a single UE MIMO, depending upon their TFI is used). The particular UEs mapped to the second stream are determinable by the order of UEs in the allocation entry component 22 so that the last M2 UEs are for the second stream. The PRBs, which are also used for the second stream, is determined by the UE indices where the serial order of UEs matching positions 26a, 26b in the component 26 matches the serial order of UEs for the positions 36a, 36b of the MMI component 36.

FIG. 4B further illustrates the result of the DL control signal of FIG. 4A as to the MU-MIMO mapping. Assume there is a total of Md=8 UEs indexed as a, b, c, . . . h. Of those UEs, M1=6 are allocated for the first stream, and M2=2 are allocated for the second stream among a total of N=12 RBs. M2=2 in the second stream (UE indices “g” and “h”) and the corresponding M2=2 in the first stream (UE indices “b” and “d”) are using MU-MIMO. The remaining M1−M2=4 (UE indices “a”, “c”, “e” and “f”) are using SISO or single-user MIMO. In the UE index component 26, the UEs are mapped to the N=12 resource blocks as shown in the first stream mapping 39, where UE identified as “a” is mapped to the RBs numbered as N=1, 5 and 6; the UE identified as “b” is mapped to the RBs numbered as N=2, 3 and 11, etc. Note that there are six different UE indices (a through f) within the RB mapping of the UE index component 26, so the length field 30 would indicate length=M1=6 even though twelve RBs are mapped there. The MMI component 36 shows bit “0” for the first position 36a (the RB N=1), which is mapped at the first UE index sequence component 26 to the UE identified as “a”, so that UE (“a”) is allocated only on the first stream 39. In the next position 36b, the second RB N=2 is allocated (on the first stream) to the UE identified as “b” and the corresponding bit in the MMI component 36 is bit “1”, indicating MU-MIMO. As indicated by all MMI bits, only UEs “b” and “d” are allocated for MU-MIMO in the first stream. Thus, M2=2, and the last M2=2 UEs “g” and “h” are allocated in the second stream for MU-MIMO. Then Md=M1+M2=8 can be also know to the receivers of this control signal.

The pairing arises in that those UEs allocated on the second stream 40 are identified by those indicated by a bit “1” in the first stream 39. Using the convention that the MU-MIMO allocated UEs are the M2 last sequential UEs of the Md index mapped in the allocation entry component 22, then in FIG. 4B there are M2=2 UEs allocated for the second stream using MU-MIMO, and those two are identified as UEs “g” and “h” of the total (Md) a through h UEs. Since the second position 36b is bit “1” and is mapped to the UE identified as “b”, the pairing convention above therefore indicates that the UE identified as “g” (the second to last sequential UE since M2=2) is mapped by that second position 36b to MU-MIMO on the second stream 40 for the RB N=2. As seen in FIG. 4B, the UE identified as “g” is allocated for the second stream 40 of RBs N=2, 3 and 11, each corresponding to a direct map in the UE index sequence component 26 for the UE identified as “b”. Correspondingly, the UE identified as “h” is allocated MU-MIMO for only RB N=8, as that UE is paired with the UE identified as “d”, which is the next UE that is not “b” having a bit “1” in the MMI component 36. As such, the pairing is not explicit but inherent for this embodiment.

For the control signal allocating UL resources under this pairing restriction embodiment, shown in FIG. 5A, the difference as compared to the DL resource allocation signal of FIG. 4A is that the allocation type component 24 (localized or distributed) is not used on the UL. The ACI component 34 indicates which UEs continue their allocation to the next RB (and by exception, which do not). M1 is known from the number of bit “1” or continuation indications in the ACI component 34. The MMI component 38 indicates MU-MIMO for the UEs corresponding to the positions of the bit “1” indications. The total UEs for which this UL resource allocation signal applies is Mu, known from the total of M1 and the number (M2) of bit “1” indications in the MMI component 38. Therefore, there are M2=Mu−M1 UEs on the second stream, and 2*M1−Mu bit “0” indications in the MMI component 38. Because this control signal for UL resource allocation carries the restriction noted above for pairing UEs for MU-MIMO, resources are again allocated to pairs of UEs.

If alternatively Mu is explicitly signaled in the UL resource allocation control signal, the length of the MMI component 38 may be dynamically shortened as follows. After there have been Mu−M1 bit “1” indications or 2*M1−Mu bit “0” indications in the MMI component 38, the remaining bits are redundant bit “0” or bit “1” indications (respectively), so the MMI component may be truncated there as compared to the full number of M1 positions for the M1 distinct UEs allocated for the first stream. This dynamic shortening may also be extended to other embodiments described herein.

FIG. 5B illustrates the result of the UL resource allocation control signal of FIG. 5A. Since the first stream 39 of the N=12 RBs are allocated to UEs identified as “a” through “e” in FIG. 5B, it is known that M1=5. The ACI component 34 indicates that UEs identified as “a” through “e” each continues with respective RBs N=3, 4, 8, 10 and 12. The MMI component shows bit “1” for the UEs corresponding to positions for UEs “b”, “c” and “e”. There are the same number of MMI bits as the number of UEs allocated in the first stream, and the order of MMI bits corresponds to the order of UE indices for establish the mapping. By pairing, the remaining M2=3 UEs “f”, “g” and “h” (those not allocated on the first stream) are then allocated on the second stream 40 at RBs N=4 (for “f”), 5 through 8 (for “g”) and 11-12 (for “h”). Due to the pairing restriction, anytime the first stream of an RB is allocated, there need be only one MMI indicator for a consecutive series of allocated RBs (e.g., one MMI bit “1” to allocate MU-MIMO RBs 5-8 to the UE pair “c” and “g”). Note that UEs “a”, and “d” are enabled for SISO or single user MIMO (depending on their TFI in the allocation entry component 22) at RBs N=1-3 and N=9-10, respectively. They share neither the first nor second stream with any other UEs for these RBs. UEs “b”, “c” and “e” are allocated on the first stream 39 for RBs 4, 5-8 and 11-12 respectively, with their respective paired UEs “f”. “g” and “h” allocated on the second stream 40 of those same RBs.

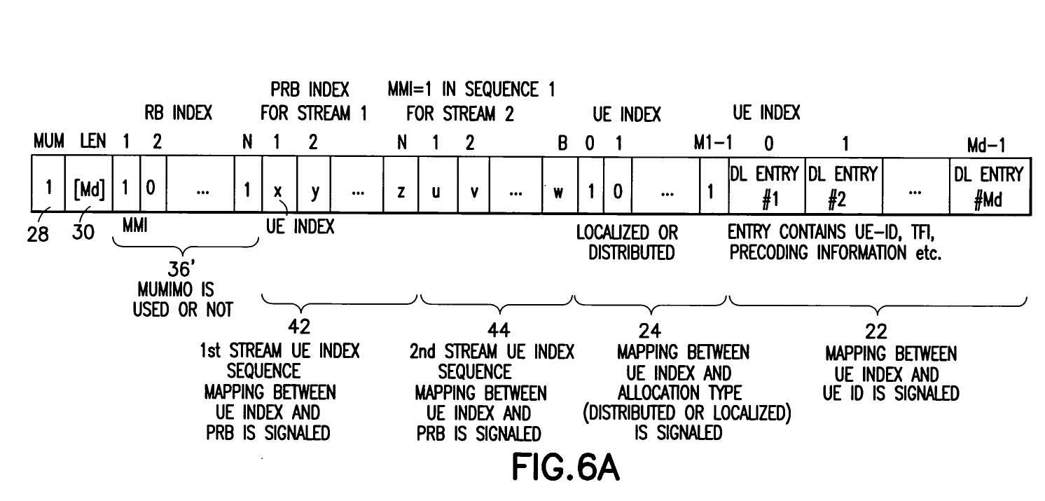

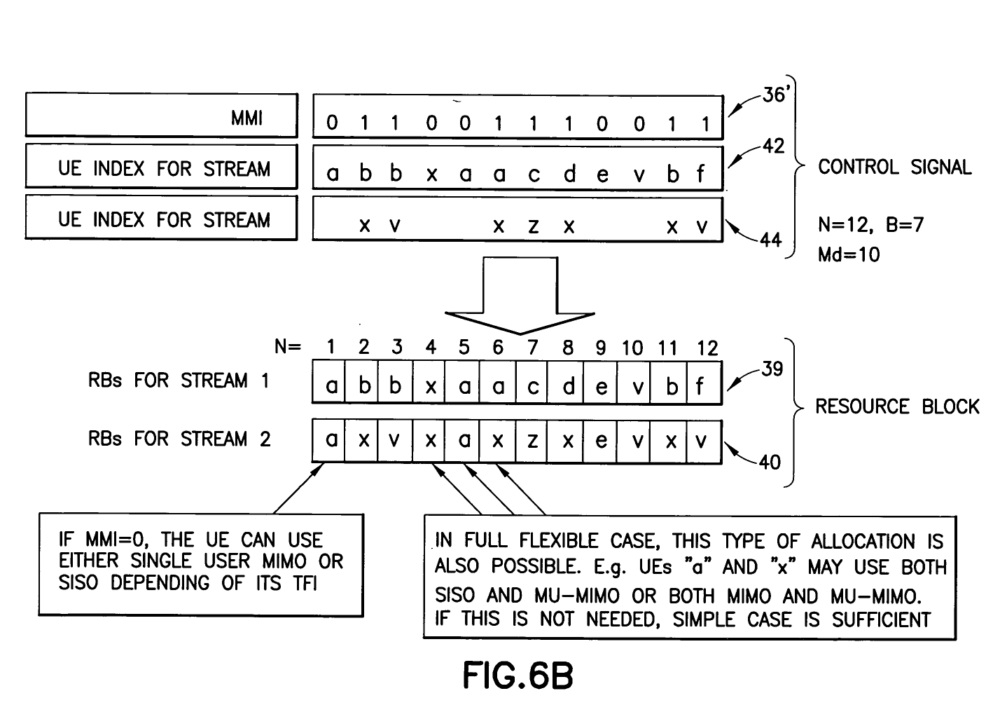

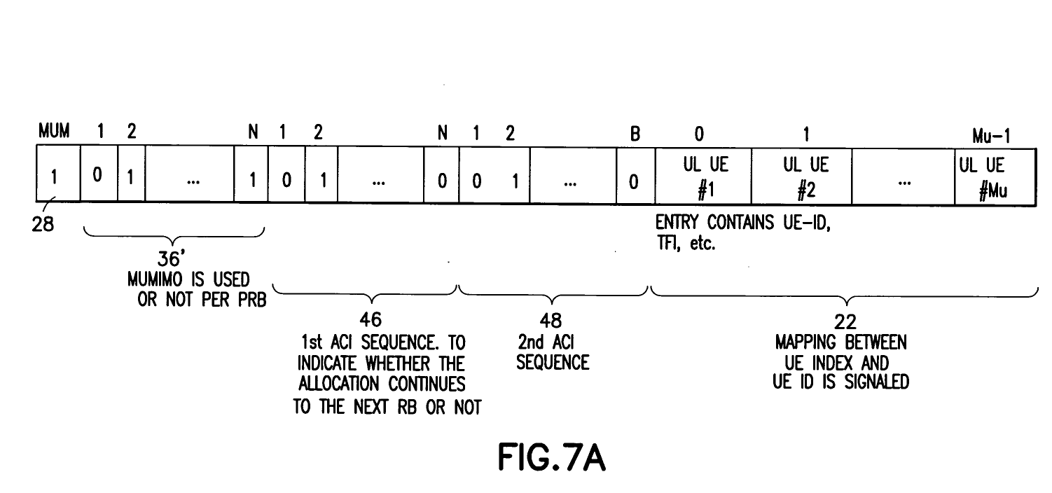

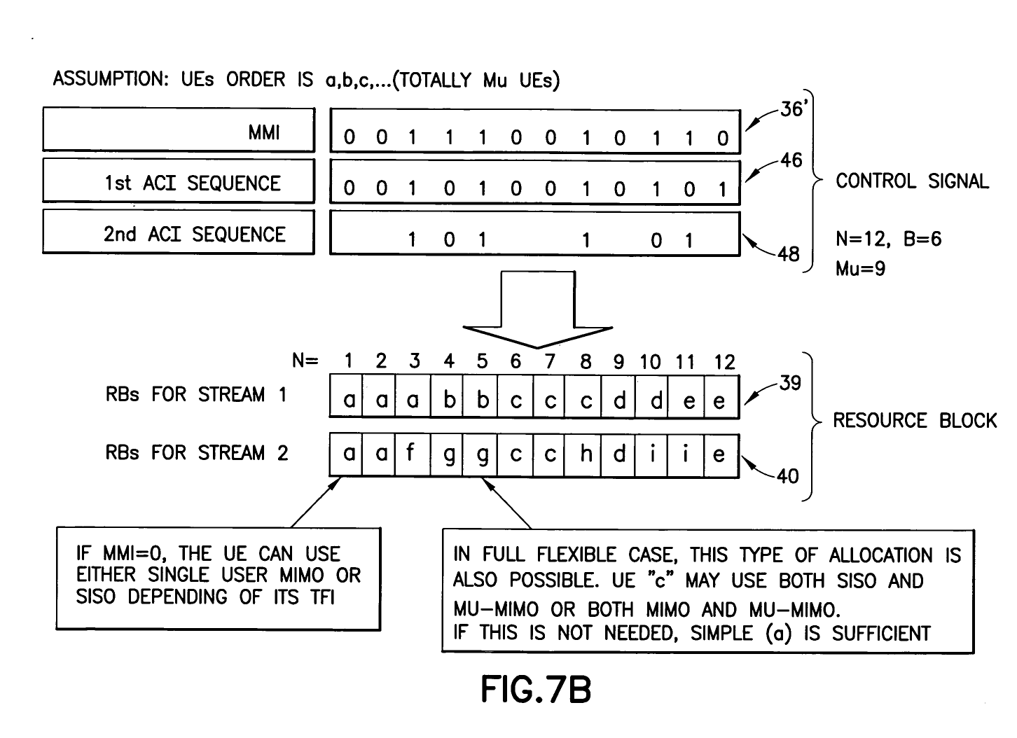

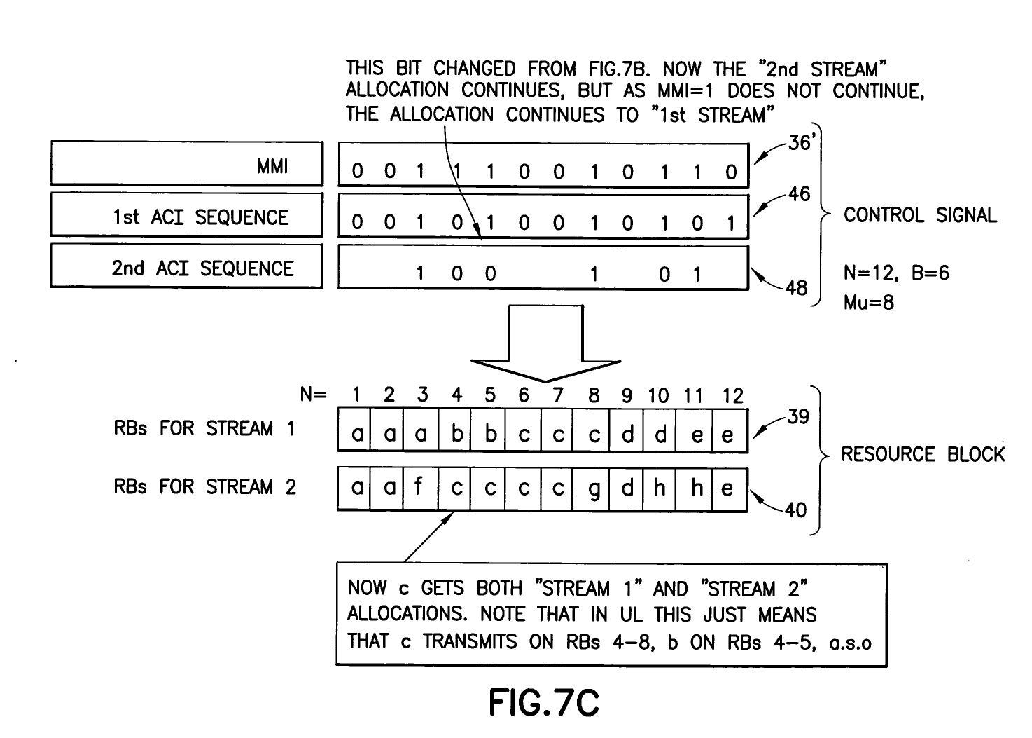

FIGS. 6A-6B show a DL control signal to allocate DL resources in a manner that is fully flexible, that is, not restricted by pairing as in the embodiments of FIGS. 4A-4B and 5A-5B. FIGS. 7A-7B show a fully flexible DL control signal for allocating UL resources. In FIG. 6A, the shared control signal retains the allocation entry component 22, the allocation type component 24, the MUMIMO field 28, and the length field 30 as above. The length field 30 indicates Md in this embodiment. The MMI component 36′ in this full flexible embodiment now indicates which RBs are allocated for MU-MIMO by a bit “1” indication, as opposed to indicating which UEs are allocated MU-MIMO as in the pair-restricted embodiment above.

In addition to those components, two new components are added to the control signal in this embodiment: a first stream UE index component 42, and a second stream UE index component 44. There are N RBs in the first stream UE index component similarly to FIG. 4. There are B RBs allocated for MU-MIMO, which is indicated in the MMI component 36′ as bit “1” indications for those particular RBs. The total of the RB allocations are spread among Md UEs. The second UE index component 44 identifies a series of UEs that are allocated on the second stream. The RBs on which those UEs are allocated are the series of RBs, in order, for which the MMI component 36′ bears a bit “1”. Since B RBs are identified in the MMI component 36′ as being allocated for MU-MIMO, it follows then that there are B positions within the MMI component 36′ that are bit “1”, so B is known from the control signal. The length field 30 indicates the length of the UE index, either directly as in a ceiling operation, or indirectly as Md. M1 is obtained from the number of different UE indices in the list of N UEs of the first stream UE index component 42. If Md is not explicit in the length field 30, it may be obtained from the number of different UE indices in the combined list N+B for the first and second stream UE index components 42, 44.

FIG. 6B shows the result of the control signal of FIG. 6A. The MMI component 36′ shows that RBs N=2, 3, 6, 7, 8, 11 and 12 are allocated for MU-MIMO. The first stream UE index component 42 lists for each position a UE index, so that the series of N UEs in that component 42, one for each position, matches the sequential string of N RBs being allocated for this first stream. The second stream UE index component 44 lists those UEs allocated on the second stream. For those RBs indicated as MU-MIMO (bit “1”) in the corresponding position of the MMI component 36′ (B of the total N RBs), the UE identified in the second stream UE index component 44 is matched to a particular MU-MIMO RB so as to align column wise as in FIG. 6B. The result is the first stream 39 and the second stream 40 for the various N RBs as shown. Note that for MMI with bit “0”, only on the first stream 39 is a UE explicitly allocated (e.g., “x” at N=4) at the component 42. In those instances, the allocated RB is either SISO or single-user MIMO, depending upon that UEs TFI. This embodiment is fully flexible because there is no mandated pairing of UEs. For example, UE “a” is allocated SISO/single user MIMO at RBs N=1 and 5; is allocated MU-MIMO with UE “x” at RB N=6, and “x” is not always paired with “a” as shown by RBs N=2, 4, 8 and 11 where “x” shares an RB with “b” (in MU-MIMO) at N=2 and 11, with “d” at N=8, and is allocated SISO/single user MIMO at N=4.

FIGS. 7A-7C illustrate the uplink resource allocation control signal corresponding to the full flexible embodiment noted for FIGS. 6A-6B. The MMI component 36′ indicates in each of N positions whether MU-MIMO is used or not used for each of the N RBs being allocated; one position corresponding to one RB. As above, there are then B bit “1”s in the MMI component 36′. A first ACI component 46 indicates, for each of N RBs, which ones are continued in the first stream for the next allocation. A second ACI component 48 indicates which of the B MU-MIMO-allocated RBs are continued in their second stream for the next allocation. The total of the bit “1” indications for the first and second ACI sequence components 46, 48 yields the total number of UEs being allocated, Mu=N+B. The same result may be obtained by counting the number of positions (N positions) in the MMI component and the number of bit “1”s (B of them) in that same MMI component. Mapping of the UEs to the RBs uses the previous sequence of the UEs. Similar to that described for FIG. 6A, the shared control signal retains the allocation entry component 22, the allocation type component 24, and the MUMIMO field 28. The MMI component 36′ in this full flexible embodiment now indicates which RBs are allocated for MU-MIMO by a bit “1” indication, as opposed to indicating which UEs are allocated MU-MIMO as in the pair-restricted embodiment above.

As seen in FIG. 7B, the Mu=9 different UEs are allocated among the N=12 RBs as follows. The first stream 39 follows from the allocation entry component 22. The MMI component 36′ indicates which of the RBs are used for MU-MIMO, RBs N=3-5, 8 and 10-11 as shown. The first stream ACI component 46 indicates which RBs are continued on the first stream into the next allocation. The second stream ACI component 48 indicates which allocations of MU-MIMO RBs on the second stream continue into the next allocation.

FIG. 7C changes the bit for N=2 in the second stream ACI component 48 from bit “1” (do not continue) to bit “0” (continue). The relevant distinction between FIGS. 7B and 7C is that for RB N=5, the second stream is continued for UE “c” from the second stream to the first stream at RB number 5 where the continuation of the second stream stops .

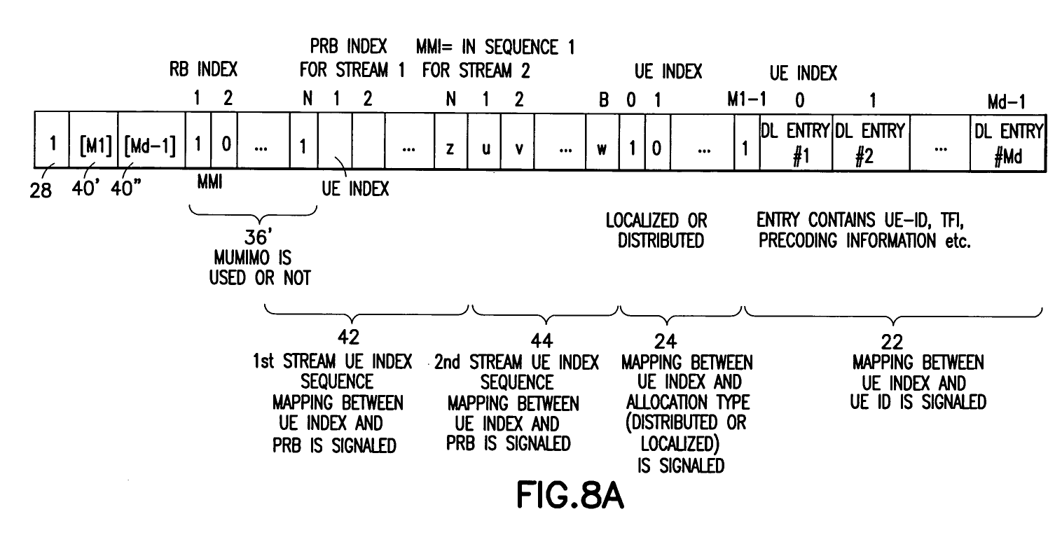

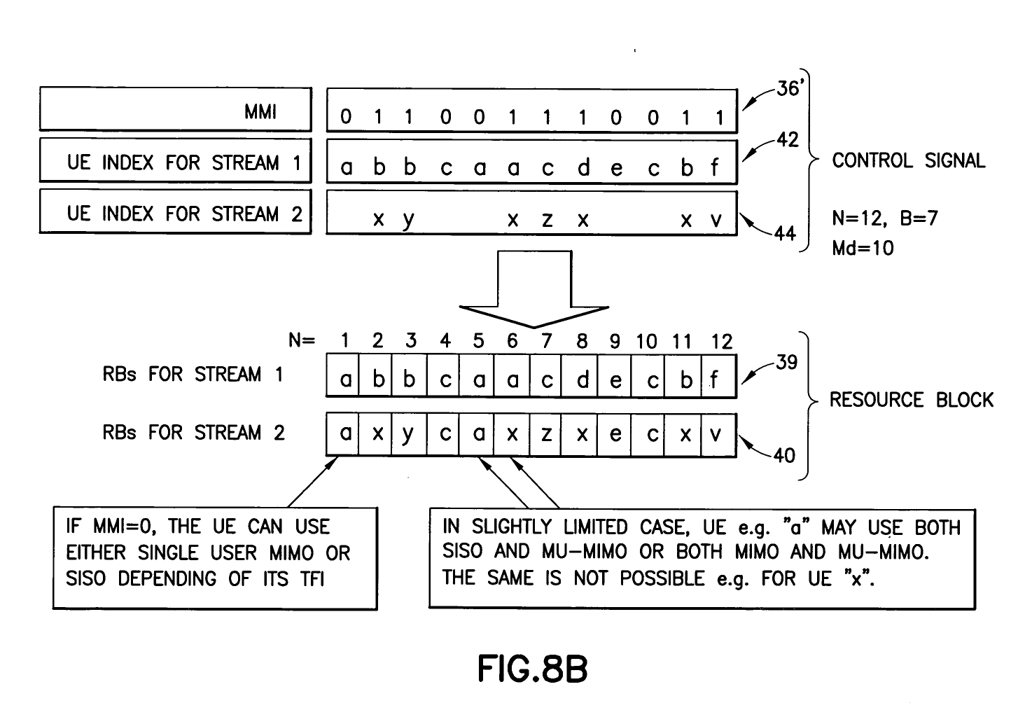

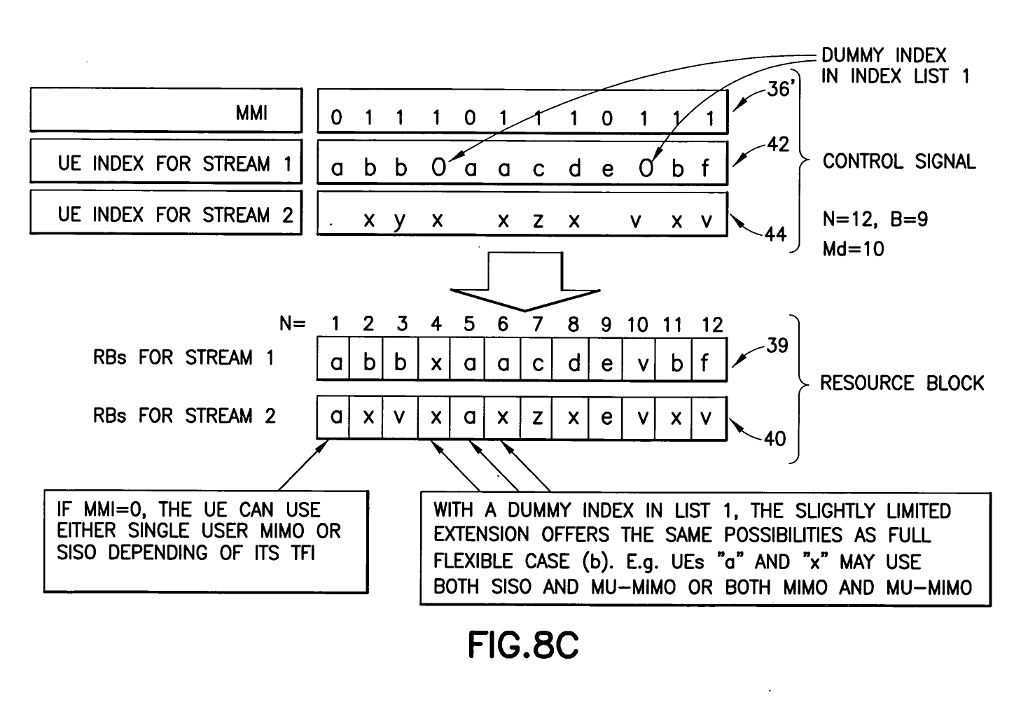

FIGS. 8A-C illustrate another embodiment of a DL resource allocation signal in which either a dummy index is used to enable full flexibility in allocating MU-MIMO RBs, or a slightly restricted allocation of MU-MIMO among the UEs if no dummy index is used. As compared to FIG. 6A, a first length field 40′ and a second length field 40″ in FIG. 8A replaces the length field of FIG. 6A. The first length field 40′ indicates the length of UE indices in the first stream UE index component 42, either directly as a ceiling operation (ceil log_{—}2 M1) or indirectly as M1. The second length field 40″ indicates the number of distinct UE indices in the second stream UE index component 44, either directly as a ceiling operation [ceil log_{—}2(Md−M1)] or indirectly as Md−M1 or Md. Alternatively, the first length field 40′ can indicate the number of unique UEs in the first stream UE index component 42, and the value Md can be obtained by M1 plus the number of different UEs among the B UE indices of the second stream UE index component 44. The restriction for this embodiment is that the UEs identified in the second stream UE index component 44 can only be allocated on the second stream. UE indices in the first UE index component 42 and UE indices in the second UE index component 44 are totally different ones. This means that the length of each UE index in UE index components 42 and 44 can be different and shortened in FIG. 8A compared to FIG. 6A. A dummy UE index may be added to the set of UEs allocated on the first stream (in the first stream UE index component 42) to enable full flexibility as that term is described for FIGS. 6A-6B.

FIG. 8B shows an example allocation using the embodiment of FIG. 8A without the dummy UE index. As shown, while UE “a” may be allocated SISO/single user MIMO as for RB N=1 and 5 as well as MU-MIMO as in RB N=6, the same flexibility is not available to UE “x” which can only be allocated on the second stream 40 within a MU-MIMO allocation with another UE.

This limitation is resolved in FIG. 8C with the dummy UE index (“0” in the first stream UE index component 42) shown for RBs N=4 and 10. In those resource blocks, the UEs “x” and “v” are explicitly allocated only on the second stream 40, but the presence of the dummy UE index in the first stream of those same RBs enables the UEs “x” and “v” to be (implicitly) allocated both streams of those respective RBs, and can use SISO or single user MIMO at those RBs (N=4 and 8) as directed by their TFI.

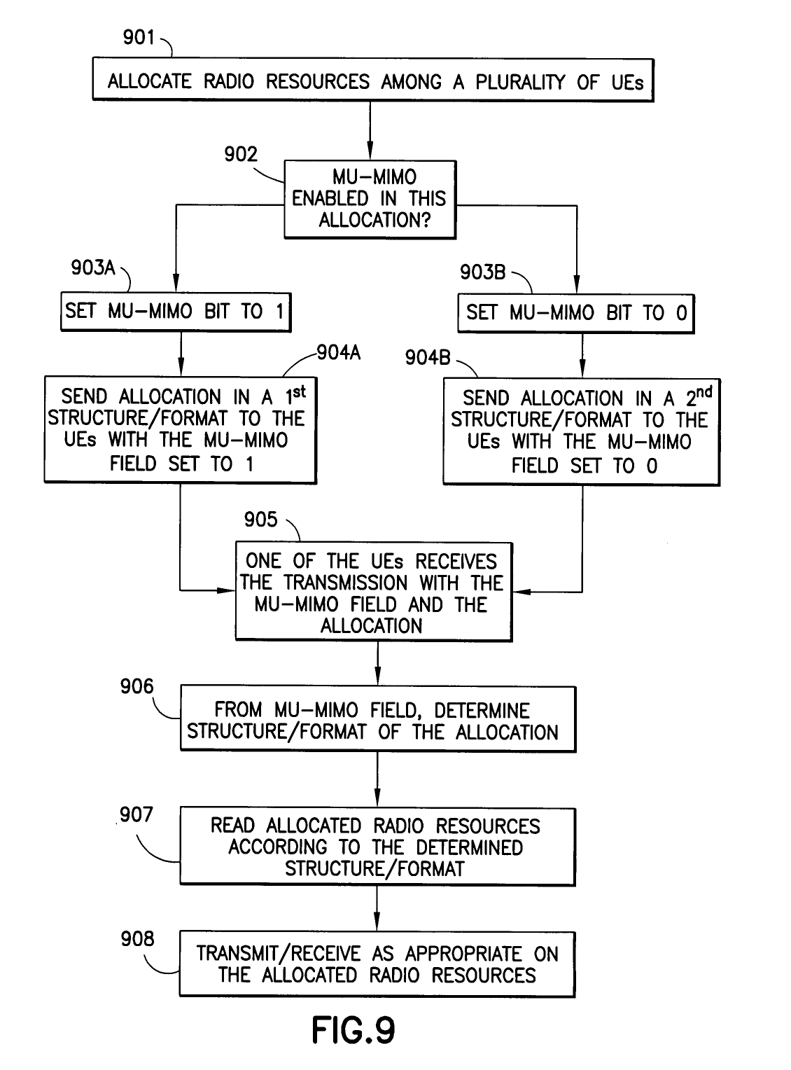

FIG. 9 illustrates process steps for both the e-Node B scheduler 12 and one of the UEs 10 being allocated. As can be seen from the above drawing figures of exemplary allocation tables, the structure/format of those allocations differs if the allocation is for MU-MIMO or not, as indicated by the bit in the MU-MIMO field 28. This is true whether the allocation is for downlink or uplink. At block 901 the e-NodeB 12 determines an allocation of radio resources among a plurality of UEs. At block 902 it is determined whether or not the chosen allocation includes MU-MIMO for any of the UEs being allocated. If yes, then at block 903A the MU-MIMO bit is set to one as seen in the above examples, and at block 904A the Node B 12 sends the allocation determined at block 901 in a first format or structure, along with the MU-MIMO field having the single bit set to one. If instead at block 902 there are no MU-MIMO allocations, then at block 903B the MU-MIMO bit is set to zero and at block 904B the Node B 12 sends the allocation determined at block 901 in a second format or structure, along with the MU-MIMO field having the single bit set to zero.

At block 905 one of the UEs being allocated receives the transmission from the Node B 12 (from blocks 904A or 904B) having the allocation and the MU-MIMO field. At block 906 the UE 10 reads the MU-MIMO field and determines the format/structure of the allocation. The MU-MIMO field informs the UE 10 not only whether MU-MIMO is enabled or not in this allocation, but how the UE is to read the allocation accompanying the MU-MIMO field. The UE reads its allocation at block 907 according to the format/structure it determined at block 906 from the MU-MIMO field, and at block 908 the UE transmits or receives (as appropriate) on the radio resources allocated to it as determined at block 907.

Embodiments of this invention may employ any suitable compression technique for the UE index list, the UE IDs themselves, the allocation entries, or any components of the control signals. Further, these components may be jointly coded, or coded in multiple parts. As a non-limiting example, those portions of the UE-specific allocation entries that are determinative of transport format, HARQ data, multi-antenna data and so forth may be separately encoded.

As may be appreciated, the use of the exemplary embodiments of this invention provides an enhanced or even unrestricted flexibility for making UE 10 resource allocations, while not requiring a burdensome level of overhead signaling and complexity.

Based on the foregoing it should be apparent that the exemplary embodiments of this invention provide a method, apparatus and computer program product(s) to provide a DL control signal for DL resource allocation that comprises an allocation entry component, a UE index sequence component, and a MU-MIMO field for indicating whether multi-user MIMO is enabled for the allocation made in that signal or not. The allocation entry component may include a UE-ID for indicating to which UE a corresponding resource is allocated, where an order of the allocation entries indicates a relationship between the UE index and the UE-ID. For the case where the MUMIMO field indicates MU-MIMO is enabled, a further length field may be included in the signal to indicate a length of a UE index used in at least one of the other components, and an MMI component indicates which RBs are allocated for MU-MIMO. In an embodiment, the UE index component lists UE indices and inherently maps to RBs by the order in which those UE indices are listed. In another embodiment, the MMI component indicates which RBs are allocated for MU-MIMO, a first UE index component indicates which UEs are allocated on a first stream of the RBs, and a second UE index component indicates which UEs are allocated on a second stream of the RBs. The second UE index component may only list those UEs for a specific RB that differs from the UE allocated for the first stream of that same RB. In another embodiment, a pairing of UEs may be used to determine which UEs are allocated on one of the streams for those RBs where MU-MIMO is indicated. In another embodiment, a dummy UE index may be used to enable SISO and/or single user MIMO on a RB, where the enabled UE is explicitly enabled only for one stream and the dummy UE index is allocated to the other stream for that RB.

Further in accordance with the described embodiments, a DL control signal for UL resource allocation may indicate via a allocation control indicator (ACI) component which RBs are to continue to the next allocation, where the control signal also includes an allocation entry component that maps UE indices to UE-IDs and also a MUMIMO field that indicates whether or not MU-MIMO is enabled for the allocated RBs. A length field may also be included in the control signal that indicates a length of a UE index in one of the other components. Where the MUMIMO field indicates that MU-MIMO is allocated, the control signal further includes an multi-user MIMO (MMD indicator component to indicate which of the RBs are allocated for MU-MIMO (two UEs on different streams of the same RB). The pairing as in the downlink may be used on the uplink in an embodiment. In another embodiment, a first ACI component indicates which RBs are to be continued on one stream and a second ACI component indicates which RBs are to be continued on another stream of the RBs, where the order of bits in the ACI components matches an order of the UEs given in the same control signal for UL resource allocation.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, or as signaling formats, or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well-established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the exemplary embodiments of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

We claim:

1. A method comprising:
determining a radio resource allocation for a plurality of user equipments;
transmitting over a shared control channel to the plurality of user equipments a control signal comprising the resource allocation and a multi-user multiple-input-multiple-output MU-MIMO field indicating whether MU-MIMO is enabled in the allocation.

2. The method of claim 1, further comprising selecting a first resource allocation structure for the case where MU-MIMO is enabled and selecting a second resource allocation structure for the case where MU-MIMO is not enabled, and wherein transmitting comprises transmitting the resource allocation in the selected structure with the field indicating whether MU-MIMO is enabled.

3. The method of claim 1, wherein the resource allocation is for downlink radio resources and comprises an allocation component listing identifiers for each of the plurality of user equipments being allocated, and the control signal further comprises a length field indicating a number of the allocated user equipments listed in a component of the resource allocation other than the allocation component.

4. The method of claim 1, wherein the resource allocation comprises an allocation component listing identifiers for each of the plurality of user equipments being allocated, a user index component that maps resource blocks to the listed identifiers, and a MU-MIMO indicator component that maps to the resource blocks and indicates for each resource block whether or not it is allocated for MU-MIMO.

5. The method of claim 4, wherein the MU-MIMO component comprises a first MU-MIMO component that allocates resource blocks on a first stream and a second MU-MIMO component that allocates resource blocks on a second stream.

6. The method of claim 5, wherein the user index component comprises at least one dummy index that does not map to one of the identifiers.

7. The method of claim 1, wherein the resource allocation is for uplink radio resources and comprises an allocation component that lists identifiers for each of the plurality of user equipments being allocated, and an allocation continuation component that indicates whether resource allocations continue to the next resource block.

8. The method of claim 7, wherein the resource allocation further comprises a MU-MIMO indicator component that maps to resource blocks through the allocation continuation component and indicates whether or not the mapped resource blocks are allocated for MU-MIMO.

9. The method of claim 7, wherein the resource allocation further comprises a MU-MIMO indicator component that maps to resource blocks and indicates whether or not the mapped resource blocks are allocated for MU-MIMO, the resource allocation further comprising a first allocation continuation component that maps to the MU-MIMO indicator component and indicates whether first stream resource allocations continue to the next resource block, and a second allocation continuation component that maps to the MU-MIMO indicator component and indicates whether second stream resource allocations continue to the next resource block.

10. An apparatus comprising:
a processor adapted to determine a radio resource allocation for a plurality of user equipments; and
a transceiver adapted to transmit over a shared control channel to the plurality of user equipments a control signal comprising the resource allocation and a multi-user multiple-input-multiple-output MU-MIMO field indicating whether MU-MIMO is enabled in the allocation.

11. The apparatus of claim 10, wherein the processor is adapted to select a first resource allocation structure for the case where MU-MIMO is enabled and to select a second resource allocation structure for the case where MU-MIMO is not enabled, and wherein the transceiver is adapted to transmit the resource allocation in the selected structure with the field indicating whether MU-MIMO is enabled.

12. The apparatus of claim 10, wherein the resource allocation is for downlink radio resources and comprises an allocation component listing identifiers for each of the plurality of user equipments being allocated, and the control signal further comprises a length field indicating a number of the allocated user equipments listed in a component of the resource allocation other than the allocation component.

13. The apparatus of claim 10, wherein the resource allocation comprises an allocation component listing identifiers for each of the plurality of user equipments being allocated, a user index component that maps resource blocks to the listed identifiers, and a MU-MIMO indicator component that maps to the resource blocks and indicates for each resource block whether or not it is allocated for MU-MIMO.

14. The apparatus of claim 13, wherein the MU-MIMO component comprises a first MU-MIMO component that allocates resource blocks on a first stream and a second MU-MIMO component that allocates resource blocks on a second stream.

15. The apparatus of claim 10, wherein the resource allocation is for uplink radio resources and comprises an allocation component that lists identifiers for each of the plurality of user equipments being allocated, and an allocation continuation component that indicates whether resource allocations continue to the next resource block.

16. A program of machine-readable instructions, tangibly embodied on a memory and executable by a digital data processor, to perform actions directed toward transmitting a resource allocation to a plurality of users, the actions comprising:
determining a radio resource allocation for a plurality of user equipments;
transmitting over a shared control channel to the plurality of user equipments a control signal comprising the resource allocation and a multi-user multiple-input-multiple-output MU-MIMO field indicating whether MU-MIMO is enabled in the allocation.

17. The program of claim 16, the actions further comprising selecting a first resource allocation structure for the case where MU-MIMO is enabled and selecting a second resource allocation structure for the case where MU-MIMO is not enabled, and wherein transmitting comprises transmitting the resource allocation in the selected structure with the field indicating whether MU-MIMO is enabled.

18. The program of claim 16, wherein the resource allocation is for downlink radio resources and comprises an allocation component listing identifiers for each of the plurality of user equipments being allocated, and the control signal further comprises a length field indicating a number of the allocated user equipments listed in a component of the resource allocation other than the allocation component.

19. The program of claim 16, wherein the resource allocation comprises an allocation component listing identifiers for each of the plurality of user equipments being allocated, a user index component that maps resource blocks to the listed identifiers, and a MU-MIMO indicator component that maps to the resource blocks and indicates for each resource block whether or not it is allocated for MU-MIMO.

20. The program of claim 19, wherein the MU-MIMO component comprises a first MU-MIMO component that allocates resource blocks on a first stream and a second MU-MIMO component that allocates resource blocks on a second stream.

21. The program of claim 20, wherein the user index component comprises at least one dummy index that does not map to one of the identifiers.

22. An apparatus comprising:
processing means for determining a radio resource allocation for a plurality of user equipments, and for selecting a first resource allocation structure for the case where MU-MIMO is enabled in the allocation and for selecting a second resource allocation structure for the case where MU-MIMO is not enabled in the allocation; and
transmitting means for transmitting over a shared control channel to the plurality of user equipments a control signal comprising the resource allocation in the selected structure and a multi-user multiple-input-multiple-output MU-MIMO field indicating whether MU-MIMO is enabled in the allocation.

23. The apparatus of claim 22, wherein:
the processing means comprises a digital data processor; and
the transmitting means comprises a transceiver.

24. A method comprising:
receiving over a shared control channel a control signal comprising the resource allocation and a multi-user multiple-input-multiple-output MU-MIMO field indicating whether MU-MIMO is enabled in the resource allocation, wherein the resource allocation comprises an allocation entry component that comprises user identifiers that map to indexes of a user index sequence component that maps to resource blocks;
mapping one of the user identifiers to one of the indexes;
determining an allocated resource block from a position of the mapped index;
determining from the MU-MIMO field whether or not the allocated resource block is allocated for multi-user multiple-input-multiple-output; and
one of transmitting or receiving on the allocated resource block according to the determined MU-MIMO allocation.

25. The method of claim 24, wherein the received resource allocation is for a downlink resource and further comprises a length field that maps to other than the allocation entry component.

26. The method of claim 25, wherein the received resource allocation further comprises a MU-MIMO indicator component that maps to the resource blocks and indicates for each mapped resource block whether or not it is allocated for MU-MIMO.

27. An apparatus comprising:
a transceiver adapted to receive over a shared control channel a control signal comprising the resource allocation and a multi-user multiple-input-multiple-output MU-MIMO field indicating whether MU-MIMO is enabled in the resource allocation, wherein the resource allocation comprises an allocation entry component that comprises user identifiers that map to indexes of a user index sequence component that maps to resource blocks; and
a processor adapted to map one of the user identifiers to one of the indexes, to determine an allocated resource block from a position of the mapped index, and to determine from the MU-MIMO field whether or not the allocated resource block is allocated for multi-user multiple-input-multiple-output;
wherein the transceiver is further adapted to transmit or receive on the allocated resource block according to the determined MU-MIMO allocation.

28. The apparatus of claim 27, wherein the received resource allocation is for a downlink resource and further comprises a length field that maps to other than the allocation entry component.

29. The apparatus of claim 28, wherein the received resource allocation further comprises a MU-MIMO indicator component that maps to the resource blocks and indicates for each mapped resource block whether or not it is allocated for MU-MIMO.
